(19) United States
(12) Patent Application Publication
(10) Pub. No.: US 2007/0129080 A1
(43) Pub. Date: Jun. 7, 2007

(54) Dynamic channel allocation method and dynamic channel allocation apparatus

(75) Inventors: Masato Okuda, Kawasaki (JP); Takashi Hatano, Kawasaki (JP)

Correspondence Address: SWIDLER BERLIN SHEREFF FRIEDMAN, LLP;The Washington Harbour, North West Suite 300, 3000 K Street, Washington, DC, 20007-5116, US

(73) Assignee: FUJITSU LIMITED

(21) Appl. No.: 11/392,776

(22) Filed: Mar. 30, 2006

(30) Foreign Application Priority Data
Dec. 2, 2005 (JP) 2005-348858

(51) Int. Cl. H04Q 7/20

(52) U.S. Cl. 455/452.1

(57) ABSTRACT

(1) Base stations are divided into base station groups which do not mutually interfere with one another. (2) Priorities of the use of channels are set for each base station group, and each base station holds a priority table showing the priorities of the use of channels. (3) Each base station derives a channel to request, and informs about the channel to adjacent base stations. (4) When the requested channel of the base station overlaps with a requested channel of the adjacent base station, each base station refers to the priority table and autonomously judges whether the requested channel can be used or not. Therefore, it is no longer necessary to wait for a response to the requested message or to confirm with the adjacent base stations regarding the availability of channels, and reduction of the throughputs and prompt channel allocation are possible.

### CROSS-REFERENCE TO RELATED APPLICATIONS

This application is based upon and claims the benefit of priority from the prior Japanese Patent Application No.2005-348858, filed on Dec. 2, 2005, the entire contents of which are incorporated herein by reference.

### BACKGROUND OF THE INVENTION

1. Field of the Invention

The present invention relates to a channel allocation method and apparatus in a wireless communication system, and particularly to a dynamic channel allocation method and a dynamic channel allocation apparatus for dynamically allocating channels in response to increase/decrease of traffic.

2. Description of the Related Art

Effective allocation of channels is carried out in order to effectively use a wireless resource. Here, “channel” is defined by time, frequency, or a combination thereof. It is defined by a code in the CDMA technology.

“Channel Assignment Schemes for Cellular Mobile Telecommunication Systems: A Comprehensive Survey” (I. Katzela, et. Al., IEEE Personal Communications, June 1996) extensively presents a static channel allocation method in which a primary application statically allocates channels in a cellular network as voice traffic, a dynamic channel allocation method, and a combination of the static channel allocation method and dynamic channel allocation method.

In these technologies, however, the voice traffic at low speed and a constant rate is the target, thus these technologies are not suitable for effectively using radio resource to transmit a data traffic with a strong burst property.

On the other hand, Japanese Patent Application Laid-Open No. 2000-078651 discloses a dynamic channel allocation method for effectively storing such data traffic. This patent application discloses a method in which, in a wireless communication network having base stations with queues, use of the same queue simultaneously between the base stations which mutually interfere with each other is prohibited so that channel allocation in accordance with the length of a queue is periodically performed the responses from the base stations and other network entity.

According to the channel request method disclosed in Japanese Patent Application Laid-Open No.2000-078651, a channel request is sent to the adjacent base stations, a response on whether or not a channel can be borrowed is received, and at the same time an inquiry/confirmation regarding whether or not another adjacent base station uses the same channel is performed.

Furthermore, in the LP base method, a base station configuring a MIS (Maximum Weight Independent Set) is derived to allocate channels. For this reason, the calculation amount for deriving the MIS becomes large as the network expands, and, since the device for executing such calculation is required at the center of the network, not only is a calculation delay significant, but also a time delay for exchanging message.

In the carrier raking method, one base station becomes active as compared to the surrounding adjacent base stations (surrounding base stations are passive), and extra channels can be used preferentially for a fixed period of time. In the case in which the active base station does not use up the extra channels, and even if there is a passive base station which requests for more channels, the base station cannot use the extra channels, thus the efficiency decreases.

The dynamic channel allocation method described in Japanese Patent Application Laid-Open No. 2000-078651 has the following problems.

In the channel request method, transmission of a request for borrowing a channel, reception of a response, and inquiry/confirmation regarding whether or not other adjacent base station uses the same channel need to be performed for each of the adjacent base stations. Therefore, the transmission of a request, response to the request, and the confirmation need to be carried out separately for each base station, but a high throughput is required and a delay for exchanging messages is significant, thus the efficiency in the use of channels can possibly be reduced.

In the LP base method, the calculation amount for deriving the MIS becomes large as the network expands, since the device for executing such calculation is required at the center of the network, not only is a calculation delay significant, but also a time delay for exchanging message. For this reason, especially in a large-scale network, the efficiency in the use of channels can possibly be reduced due to the increased delays.

In the carrier raking method, in the case in which an active base station does not use up extra channels, and even if there is a passive base station which requests for more channels, the base station cannot use the extra channels, thus the efficiency decreases.

### SUMMARY OF THE INVENTION

The present invention is contrived in view of the problems described above, and an object thereof is to provide a dynamic channel allocation method capable of improving the throughputs and the efficiency in the use of channels, and a dynamic channel allocation apparatus which implements the dynamic channel allocation method.

In order to achieve the above object, a first dynamic channel allocation method of the present invention is a dynamic channel allocation method for dynamically allocating a plurality of channels of a wireless communication network having a plurality of base station groups comprising base stations which do not mutually interfere with one another, wherein the method comprises in each of the base stations: a informing step of informing channel information requesting for the use of a channel to adjacent base stations which mutually interfere with one another; and a determination step of determining a channel to be used, in accordance with the priority of each base station group for the use of a channel, the priority being defined for each channel, on the basis of the channel information of the base stations of the base station groups and the channel information of the adjacent base stations.

A second dynamic channel allocation method of the present invention, according to the first dynamic channel allocation method, further comprises a channel information creation step in which each base station creates the channel information on the basis of the traffic amount of the base station.

In a third dynamic channel allocation method of the present invention, according to the second dynamic channel allocation method, the channel information creation step comprises a step of taking the number of channels, which are sufficient for transmitting a traffic of the base station within a period until the next channel information is informed, as the minimum number of channels requested.

In a fourth dynamic channel allocation method of the present invention, according to the second dynamic channel allocation method, the channel information creation step comprises a step of determining the number of required channels in proportion to time for transmitting the traffic.

In a fifth dynamic channel allocation method of the present invention, according to the second dynamic channel allocation method, the channel information creation step comprises a step of determining the number of channels on the basis of the traffic amount of each service class and the weight of the each service class.

In a sixth dynamic channel allocation method of the present invention, according to the second dynamic channel allocation method, the channel information creation step comprises a step of selecting a channel requested for use, from the high-priority channels in a base station group to which the base station belongs.

In a seventh dynamic channel allocation method of the present invention, according to the second dynamic channel allocation method, the channel information creation step comprises a step of selecting a channel having a relatively good characteristic in the base station.

In an eighth dynamic channel allocation method of the present invention, according to the second dynamic channel allocation method, the channel information creation step comprises a step of selecting a channel other than a channel which interferes with an adjacent base station of the base station.

In a ninth dynamic channel allocation method of the present invention, according to the first dynamic channel allocation method, the channel information comprises status information about whether a channel requested for use can be used or not.

In a tenth dynamic channel allocation method of the present invention, according to the first dynamic channel allocation method, the channel information comprises starting time when the channel requested for use is used.

In an eleventh dynamic channel allocation method of the present invention, according to the first dynamic channel allocation method, the channel information comprises time in which the channel requested for use is used.

In a twelfth dynamic channel allocation method of the present invention, according to the first dynamic channel allocation method, the channel information is either an uplink or downlink channel information, or both uplink and downlink channel information.

In a thirteenth dynamic channel allocation method of the present invention, according to the first dynamic channel allocation method, regarding the informing step, each base station informs the channel information, in synchronization with other base station.

In a fourteenth dynamic channel allocation method of the present invention, according to the ninth dynamic channel allocation method, regarding the informing step, each base station updates the status information and informs the channel information when a change occurs in the status information.

In a fifteenth dynamic channel allocation method of the present invention, according to the first dynamic channel allocation method, the channel information comprises the channel information of the adjacent base stations, in addition to the channel information of the base station.

In a sixteenth dynamic channel allocation method of the present invention, according to the first dynamic channel allocation method, the priority is a value which is different in each base station group for each channel.

In a seventeenth dynamic channel allocation method of the present invention, according to the first dynamic channel allocation method, the difference between the priorities in each channel between any two of the base station groups is minimum.

An eighteenth dynamic channel allocation method of the present invention, according to the first dynamic channel allocation method, further comprises a channel information creation step of creating the channel information on the basis of the traffic amount of the base station and an immediately preceding channel allocation performance.

A dynamic channel allocation apparatus of the present invention is a dynamic channel allocation apparatus for dynamically allocating a plurality of channels of a wireless communication network having a plurality of base station groups configuring base stations which do not mutually interfere with one another, and comprises: an informing portion which informs channel information requesting for use of a channel to adjacent base stations which interfere with one another; a storage portion which stores a priority table defining the priority of each base station group for each channel; and a use channel determination portion which determines a channel to be used in accordance with the priority table on the basis of the request channel information of the base station and of the adjacent base stations.

According to the first dynamic channel allocation method of the present invention and the dynamic channel allocation apparatus of the present invention, even when the channel requests compete, each base station can autonomously judge that the channels can be used, thus transmission of a response in the form of a message and confirmation of the adjacent base stations become no longer necessary.

According to the second dynamic channel allocation method, by taking a traffic state as a base, channels are allocated only to the base stations requiring the channels. According to the third dynamic channel allocation method, by deriving the minimum required number of channels, requests for channels can be made sufficiently. According to the fourth dynamic channel allocation method, instead of using the traffic amount as is, channel request/allocation can be performed according to the current status by converting the traffic into time required for transmitting the traffic, i.e. by converting the traffic into hours for occupying the channels.

According to the fifth dynamic channel allocation method, when the competition in channels is eased or even when a competition occurs, there is a high possibility that the base stations with the traffic of high QoS can secure channels. According to the sixth dynamic channel allocation method, even when competing with other base station, since possibly high-priority channels are requested, there is a high possibility that the requested number of channels can be secured. According to the seventh dynamic channel allocation method, a channel with a high performance can be prioritized and used.

According to the eighth dynamic channel allocation method, a channel with a high performance can be prioritized and used. According to the ninth dynamic channel allocation method, use/nonuse of a channel in the base station can be judged on the basis of the information on a channel of an adjacent base station, which is determined to be used or not used. According to the tenth dynamic channel allocation method, detailed channel allocation can be performed for each channel at the intervals shorter than a predetermined publication cycle.

According to the eleventh dynamic channel allocation method, detailed channel allocation can be performed for each channel at the intervals shorter than the predetermined publication cycle. According to the twelfth dynamic channel allocation method, the channel information can respond to both the wireless communication system in which the frequency bands are divided into up frequencies and down frequencies (frequency division multiplex) and the wireless communication system in which the uplink and downlink are divided according to time slots (time division multiplex). According to the thirteenth dynamic channel allocation method, the latest requested channel of an adjacent base station can be acquired at substantially the same time, and a channel to be used by each base station is determined so that this channel can be used stably until the next requested channel is informed and until a channel is determined.

According to the fourteenth dynamic channel allocation method, the latest request channel information can be informed to the adjacent base stations promptly. According to the fifteenth dynamic channel allocation method, determination on whether channels are available can be made promptly. According to the sixteenth dynamic channel allocation method, availability of channels can be judged uniquely. According to the seventeenth dynamic channel allocation method, fairness among the base stations can be ensured. According to the eighteenth dynamic channel allocation method, there is relatively a good chance of receiving channel allocation.

### BRIEF DESCRIPTION OF THE DRAWINGS

FIG. 1 is a figure showing an example of a wireless communication network;

FIG. 2 is a figure showing an example of a priority table defining the priority of each base station group for each channel;

FIG. 3 is a figure showing an example in which each base station informs request channel information in synchronization with other base station;

FIG. 4 is a flowchart showing a process (transmission side process) of informing a request channel;

FIG. 5 is a flowchart showing a process (reception side process) of receiving the request channel information and determining a channel to be used;

FIG. 6 is a figure showing an example of the request channel information;

FIG. 7 is a figure showing an example in which four terminals communicate with one another inside a cover area of a base station A (2, 1);

FIG. 8 is a figure showing the traffic amount for each terminal and the number of required channels;

FIG. 9 is a figure schematically showing channel allocation and a response of the terminals;

FIG. 10 is a figure showing an example in which two terminals exist in each cover area of two base stations;

FIG. 11 shows an example of calculating the number of channels when considering the weight of each QoS for each terminal shown in FIG. 10;

FIG. 12 is a figure showing an example of the wireless communication network;

FIG. 13 is a figure showing request channel information having status information;

FIG. 14 is a figure showing a flowchart of processing for updating a channel request status;

FIG. 15 is a figure showing an example of transmitting the request channel information having the status information, and judging the availability of channels based on the request channel information;

FIG. 16 is a figure showing the request channel information having time information;

FIG. 17 is a figure showing an example of transmitting the request channel information having the time information and of determining a channel to be used;

FIG. 18 is a figure showing a result of allocation of a channel a;

FIG. 19 is a figure showing the distance between base stations viewed from the topological perspective and the perspective of the priorities; and

FIG. 20 is a figure showing the request channel information having information of adjacent base stations.

### DESCRIPTION OF THE PREFERRED EMBODIMENTS

Embodiments of the present invention are described hereinafter with reference to the drawings. However, the embodiments are not to limit the technical scope of the present invention.

In the present invention, through the following basic processes from (1) to (4), each base station informs one channel request message to adjacent base stations (adjacent base station: a base station in an area of interference), and each base station can autonomously judge the availability of channels on the basis of a channel request message informed by the adjacent base stations. Therefore, it is no longer necessary to wait for a response to the requested message or to confirm with the adjacent base stations regarding the availability of channels, and throughput improvement and prompt channel allocation are possible.

(1) Base stations are divided into base station groups which do not mutually interfere with one another.

(2) For each channel, priorities of the use that are different between the base station groups are set, and each base station holds a priority table indicating the priorities of the use of channels.

(3) A channel requested by a base station is derived and informed to adjacent base stations.

(4) When the requested channel of the base station overlaps with a requested channel of the adjacent base stations, each base station refers to the priority table and autonomously judges whether the requested channel can be used or not.

### First Embodiment

### Basic Pattern

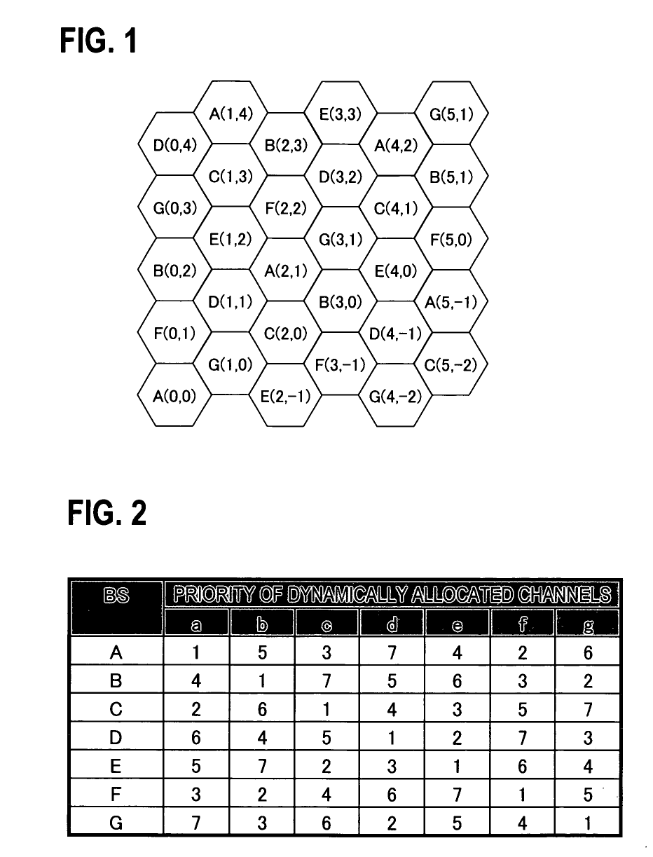

FIG. 1 is a figure showing an example of a wireless communication network. In FIG. 1, X(v, u) (X=A, B, . . . , G, v, u are coordinate axes) is an identifier of a base station, and a hexagon indicates a cover area of the base station. A through G indicate a base station group comprising base stations which do not mutually interfere with one another. For example, for a base station A(2, 1), adjacent base stations interfering with the base station A(2, 1) are base stations B(3, 0), C(2, 0), D(1, 1), E(1, 2), F(2, 2), and G(3, 1) surrounding the base station A(2, 1). The base station A(2, 1) is not placed adjacent to other base stations A(0, 0), A(5, 1), A(4, 2), and A(1, 4) that are in the base station A group, and the base stations in the base station A group are placed in position where they do not interfere with one another. It should be noted here that “BS” means a base station.

FIG. 2 is a figure showing an example of a priority table defining the priority of each base station group for each channel. The lower-case alphabets indicate channels, and the priorities of the base station groups (A through G) are defined with respect to the channels respectively. The priorities are same as the order of priority of the base stations which can use a channel when this channel is requested by a plurality of base stations.

As shown in FIG. 2, the priority on each channel is set so as not to be the same value among the base station groups. Accordingly, even when a plurality of base stations request for the use of the same channel, it can be judged that a high-priority base station can obtain the right of use, thus each base station can autonomously judge the availability of a channel uniquely.

Further, when comparing the priorities on channels between any two base station groups, the priorities are set so as to be a ratio of 4:3. For example, when comparing the priorities between the base station A and base station B, the priority of A is higher on the four channels of a, c, e, and f, and the priority of B is higher on the three channels of b, d, and g. Furthermore, A has more high-priority channels than B as indicated by the priority ratio of 4:3, but the ratio is sometimes 3:4 when comparing with other base station groups. In the example of FIG. 2, the priority ratio is set to be 3:3 where it should be 4:3 or 3:4 for other six base stations. By setting the priority table in this manner, fairness can be realized among the base stations.

It should be noted that there are seven channels this time, thus the difference between the priorities is 1. However, if the number of channels is an even number, the difference is set to be 0.

Each base station determines a channel to request for, and informs it as request channel information to adjacent base stations. Then, each base station receives request channel information of the adjacent base stations, and, if a competition occurs because the adjacent base stations request for the same channel which is requested by the each base station, checks the priority on the channel by referring to the priority table to judge the availability of the channel. Specifically, if the base station has higher priority, the base station uses the channel, and if the base station has low priority, the base station abandons the use of the channel. In this manner, even when a competition in a channel request occurs, each base station can autonomously judge the availability of the channel, thus transmission of a response in the form of a message and confirmation of the adjacent base stations are no longer necessary.

The request channel information is preferably informed in synchronization with other base station. In this manner, the latest requested channel of all of the adjacent base stations can be acquired at substantially the same time, and a channel to be used by each base station is determined so that this channel can be used stably until the next requested channel is informed and until a channel is determined.

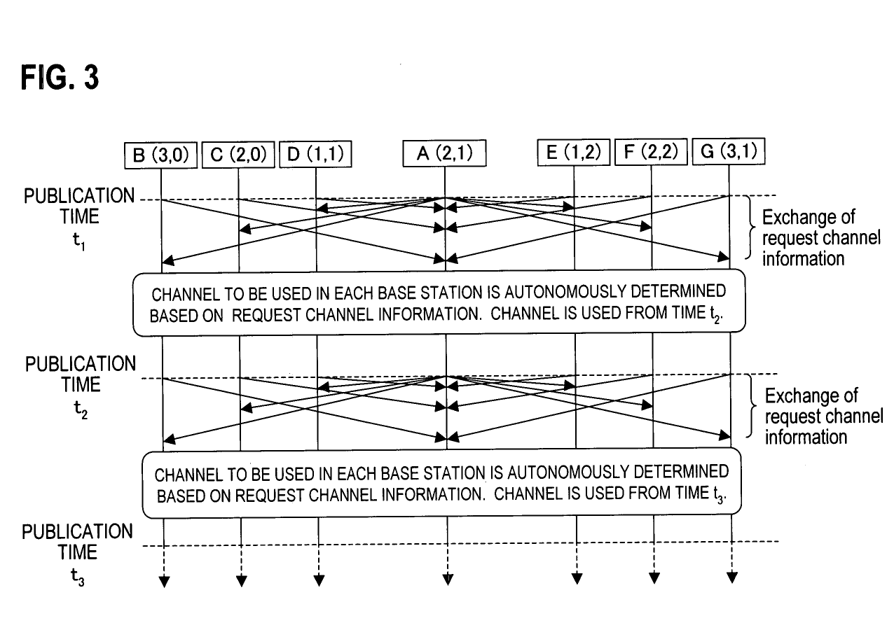

FIG. 3 is a figure showing an example in which each base station informs request channel information in synchronization with other base station. It should be noted that FIG. 3 merely shows exchange of information, centered around the base station A(2, 1). Specifically, the figure shows an example of communication between the base station A(2, 1) and the adjacent base stations B(3, 0), C(2, 0), D(1, 1), E(1, 2), F(2, 2), and G(3, 1).

In FIG. 3, the base stations exchange request channel information at time t₁ to determine whether a channel can be used between time t₂ to t₃. Similarly, at t₂, the base stations determine whether the channel can be used from the time t₃. The interval between the publication times (t₁ to t₂, t₂ to t₃) is considered as a constant cycle, but it can be varied as long as the synchronization is observed.

The request channel information may be either an up (from the terminal to base station) traffic or down (from the base station to terminal) traffic, or both up and down traffics. Specifically, in the case of the wireless communication system in which the frequency bands are divided into up frequencies and down frequencies (frequency division multiplex), channel allocation can be performed with each of the up and down traffics, and in the case of the wireless communication system in which the up and down traffics are divided according to time slots (time division multiplex), channel allocations can be performed with up and down traffics.

Further, for the synchronization of the base stations, a GPS (Global Positioning System) or the like can be used.

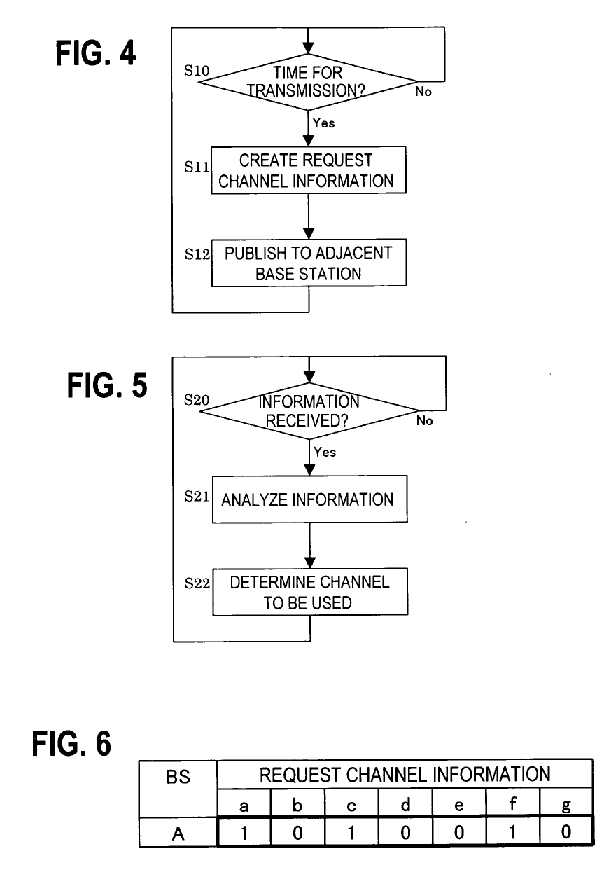

FIG. 4 is a flowchart showing a process (transmission side process) of informing a request channel. In the transmission side process, every predetermined time (S10), the request channel information is periodically created (S11), and is then informed to the adjacent base stations (S12). FIG. 6 is a figure showing an example of the request channel information. In the example of FIG. 6, the use of the channels a, c, and f is requested. It should be noted that a bitmap format is used in FIG. 6, but formats are not limited to the bitmap format.

FIG. 5 is a flowchart showing a process (reception side process) of receiving the request channel information and determining a channel to be used. In the reception side process, once the request channel information is received (S20), the information is analyzed (S21), i.e. the priority table is referred to determine a channel to be used on the basis of a comparison between the priorities of a base station and a transmitting station (S22). In FIG. 4, the request channel information can be created on the basis of the traffic status of the base station. Particularly, the traffic amount of the base station is monitored, whereby the number of channels, which is sufficient for transmitting a traffic within a period until the next request channel information is transmitted, can be taken as the minimum number of channels requested.

For example, suppose that seven frequency carriers as channels are dynamically allocated for every 100 msec in a wireless communication system in which the latest request channel information is informed. It should be noted that each of the frequency carriers is modulated appropriately at a symbol type of 100 usec.

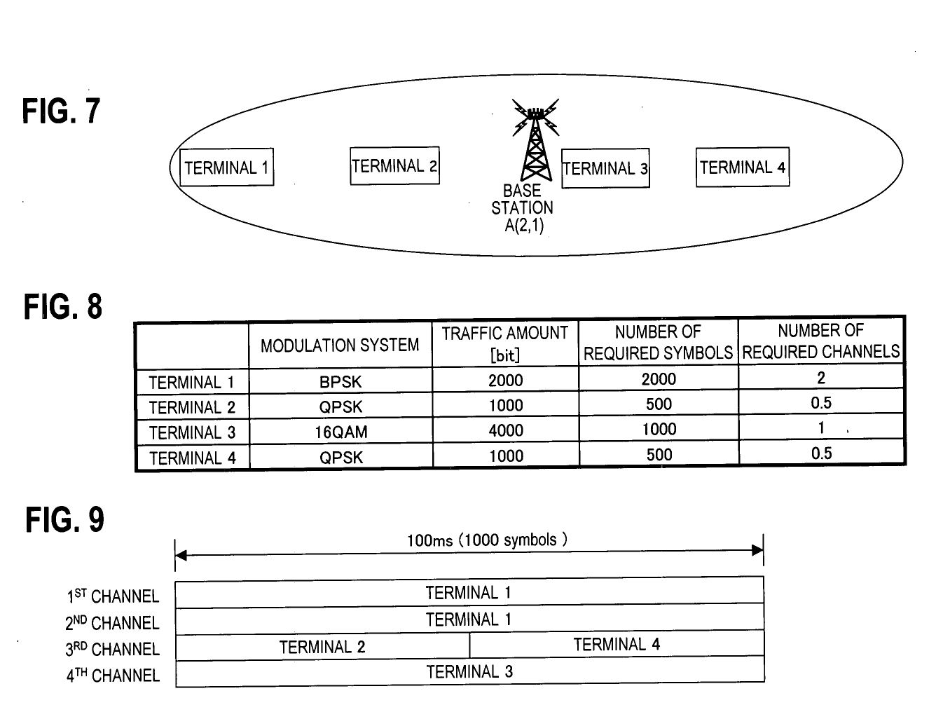

FIG. 7 is a figure showing an example in which four terminals communicate with one another inside the cover area of the base station A (2, 1). This example is used to explain the minimum number of requested channels. FIG. 8 is a figure showing the traffic amount for each terminal and the number of required channels.

In FIG. 7, suppose that a terminal 1 performs communication by BPSK since a terminal 1 is far from a base station and since radio attenuation is severe, a terminal 3 performs communication by 16 OAM since the terminal is close to the base station, and terminals 2 and 4 perform communication by QPSK. At this moment, when each terminal has the traffic amount shown in FIG. 8, in terms of the number of bits/symbols according to the modulation system, a required channel, which is necessary for each terminal to completely transmit the traffic within the transmission interval (100 ms) of the request channel information, can be derived (here, the coding rate for correcting an error, and overhear for performing various types of control operations are not considered). In this manner, instead of using the number of bytes and other traffic amount, as is, channel request/allocation can be performed according to the current status by converting the traffic into time required for transmitting the traffic, i.e. by converting the traffic into hours for occupying the channels.

As a result, the base station A(2, 1) cannot completely handle the traffics of the four terminals, unless requesting for at least four channels.

FIG. 9 is a figure schematically showing channel allocation and a response of the terminals. Two channels are allocated to the terminal 1, total of one channel is allocated to the both terminals 2 and 4, and one channel is allocated to the terminal 3.

It should be noted in the above example that the up/down traffics are not distinguished, but the minimum number of requested channels can be derived for each of the up/down traffics. Moreover, the weight of each QoS (Quality of Service) class of the traffic (service class) can be considered to derive the number of requested channels.

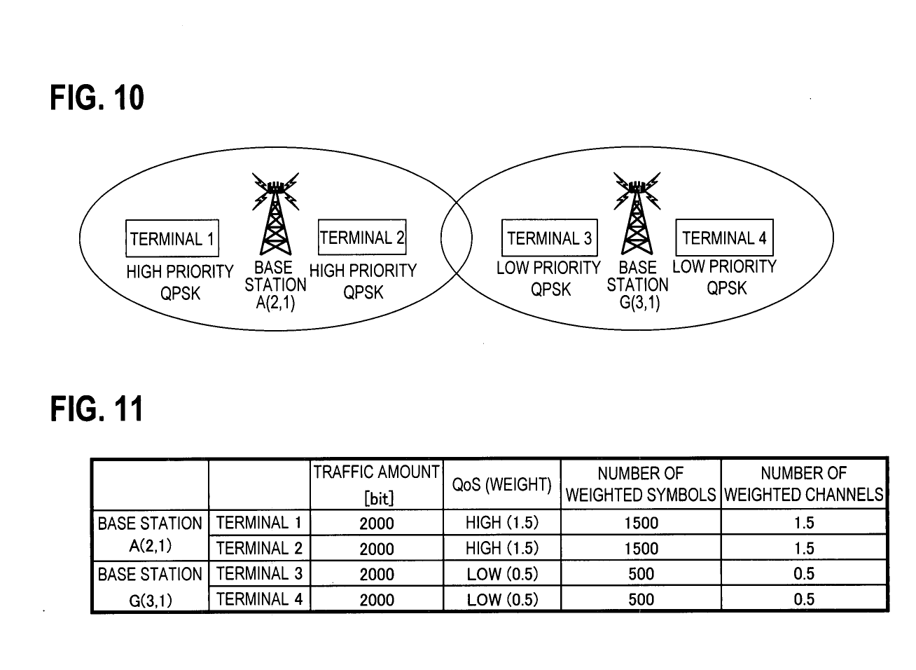

FIG. 10 is a figure showing an example in which two terminals exist in each cover area of two base stations. In FIG. 10, two terminals of the base station A(2, 1) has a high-priority traffic, and two terminals of the base station G(3, 1) has a low-priority traffic. The conditions applied for each terminal, other than the condition of QoS class, will be the same.

FIG. 11 shows an example of calculating the number of channels when considering the weight of each QoS for each terminal shown in FIG. 10. Here, the high-priority weight is defined as 1.5, and low-priority weight is defined as 0.5. As a result of FIG. 11, the base station A(2, 1) requests for three channels, and the base station G(3, 1) requests for only one channel. The channel which can be actually used depends on the request channel of the adjacent base station. However, when the number of requested channels of a base station having more traffics of high QoS becomes higher than the number of requested channels of a base station having more traffics of low QoS, the competition in channels is eased. Even when a competition occurs, there is a high possibility that the base stations with the traffics of high QoS can secure the channels.

Each base station determines the number of channels requested, and at the same time selects which channel to request. Selection of a channel to request can be performed in the order of priority from the high-priority channel for the base station, with reference to the priority table.

For example, when the base station A(2, 1) request for three channels, three channels a, f, and c are informed as the requested channels by means of the priority table of FIG. 2. Accordingly, even when a competition occurs between the base station and other base station, since a high-priority channel is requested, the number of channels requested is more likely to be secured.

On the other hand, it can be considered that the characteristics of a specific frequency are extremely poor depending on the surrounding wave conditions. In this case, it is preferred that a requested channel be selected from those channels excluding the poor quality channels, instead of selecting a channel in the order of priority.

For example, in the above example, when the characteristics of a channel f is extremely poor, the base station A(2, 1) informs three channels a, c, and e as the requested channels. Accordingly, a channel with a high performance can be prioritized and used. Furthermore, those channels with poor performances in a certain base station area can be channels with good performances in other base station area, thus the frequencies can be used effectively.

Moreover, a requested channel can be selected on the basis of an immediately preceding allocation performance. Specifically, the channel which has been last allocated is prioritized and selected as the requested channel. Accordingly, there is relatively a good chance of receiving channel allocation.

### Second Embodiment

### Repetition of Publication

In FIG. 3, exchange of the request channel information is carried out once. However, this exchange performance cannot respond to a situation in which an available channel to an adjacent base station changes depending on the request channel information of an adjacent base station of the adjacent base station.

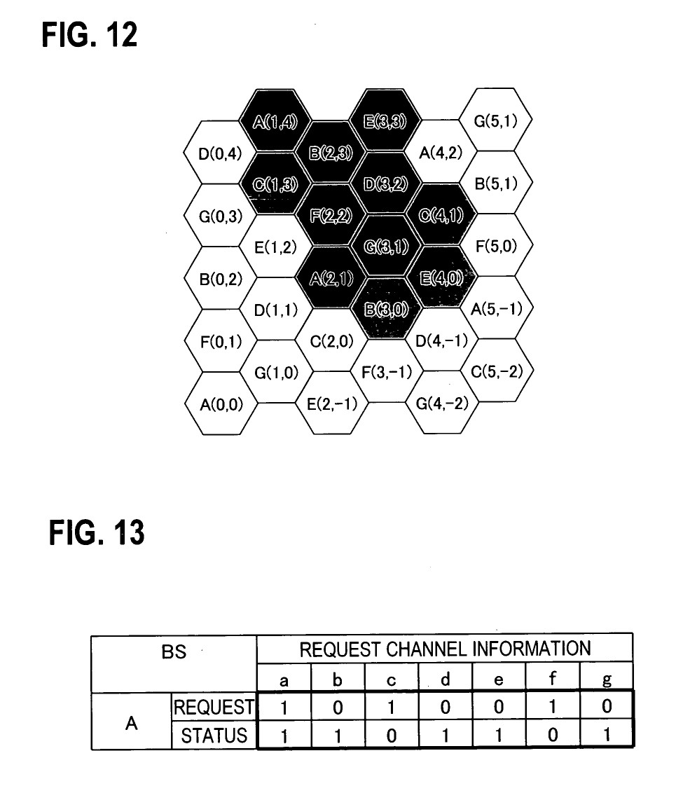

For example, the wireless communication network configured in FIG. 1 and FIG. 2 is considered as an example. FIG. 12 is a figure showing an example of the wireless communication network, and is same as FIG. 1, except that the base station A(2, 1) is colored in FIG. 12.

In FIG. 12, when the base station A(2, 1) is in an idle state (no traffic) and an adjacent base station uses a channel a (high-priority channel for the base station A), it is considered whether G(3, 1), which takes this channel as the lowest priority, can use this channel. For example, the priority on the channel is higher for B(3, 0) than G(3, 1), thus, when B(3, 0) requests for the channel a, G(3, 1) abandons the use of the channel by referring the priority table. On the other hand, when C(2, 0) also requests for the use of the channel a, since the priority on the channel is higher for C(2, 0), B(3, 0) actually cannot use the channel a. Therefore, it is insufficient for G(3, 1) to abandon the use of the channel a only because B(3, 0) requests for the channel a.

Therefore, as shown in FIG. 13, conditions such as “determined” and “provisional” can be applied to the request channel information, whereby it is possible to judge the availability/unavailability of the channel to the base station can be determined on the basis of the information of the channel which is determined to be available/unavailable to the adjacent base stations.

FIG. 13 is a figure showing the request channel information having status information. In the example of FIG. 13, status: 1 means determined, status: 0 means provisional. For the base station A, the channel a is the highest priority. Therefore, by requesting for the channel a (request flag is “1”), the use of the channel is “determined,” and the status flag becomes “1.” Regarding channels b, d, e, and g, since the use of these channels is not requested (request flag is “0”), the unused state of the channel is “determined,” and the status flag becomes “1.” Regarding channels c and f, although the use of these channels is requested (request flag is “1”), these channels are not placed as the first priority. Therefore, the availability of these channels is determined on the basis of whether the adjacent base stations taking these channels as high priorities make a request for the use of these channels. Specifically, at the point of time when the request channel information is created, the availability is undetermined, thus the status flag becomes “0” (provisional).

When the request channel information is received from an adjacent base station, on the basis of the request situation of a channel, which is in the “determined” state, the availability of the channel to the base station is determined. Further, when the availability state of a channel is changed, updated request channel information is informed to the adjacent base station. Accordingly, the latest request channel information can be informed to the adjacent base station promptly.

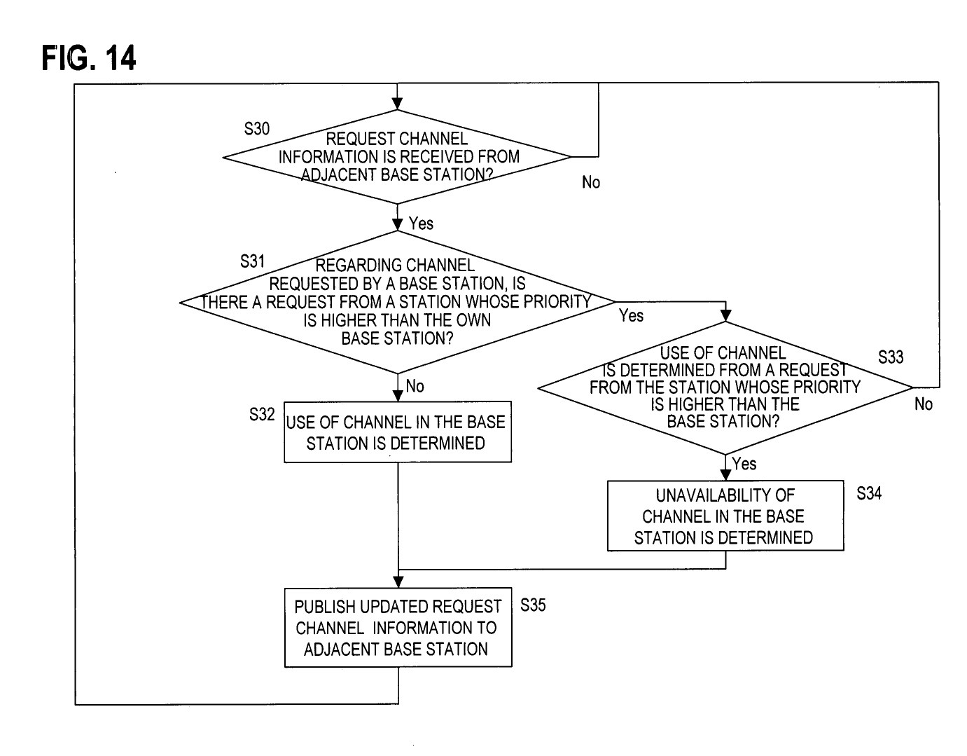

FIG. 14 is a figure showing a flowchart of processing for updating a channel request status. When the request channel information is received from an adjacent base station (S30), for a channel requested by a base station, it is judged whether there is a request for the use of the channel from a base station prioritizing the channel more than the base station (S31). If there is not request, the base station can prioritize and use the channel, thus the use of the channel at this base station is determined (S32). On the other hand, if there is the request, it is judged whether the request, which is sent from a base station prioritizing the channel more than the above base station, is determined according to the status information contained in the request channel information (S33). If determined, the unavailability of the channel to the base station is determined (S34). If not determined, availability of the channel to the base station is not yet determined. Regarding the channel which is determined to be available/unavailable, the status information of the request channel information is updated, and the updated request channel information is informed to the adjacent base stations (S35). By repeating this process, eventually the availability/unavailability of all channels is determined.

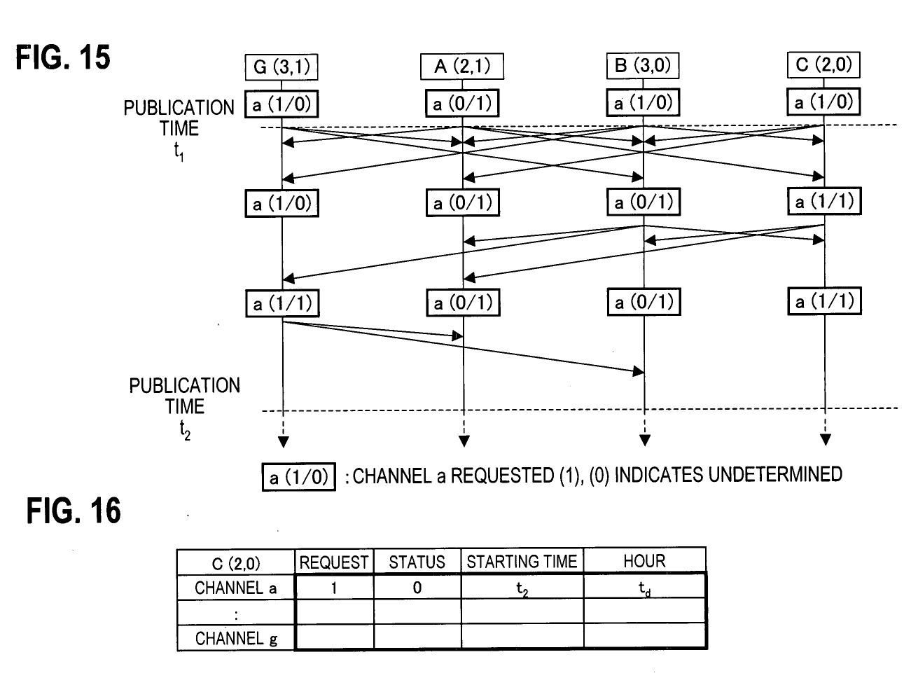

FIG. 15 is a figure showing an example of transmitting the request channel information having the status information, and judging the availability of channels based on the request channel information.

In FIG. 15, as in the above example, supposed that the base station A(2, 1) is unable to use the channel a, and that the base stations other than the base stations G(3, 1), B(3, 0) and C(2, 0) do not request for the use of the channel a.

When the time t₁ for informing the request channel information is reached, each of the base stations informs the request channel information to adjacent base stations. Here, since G(3, 1) and C(2, 0) do not lie adjacent to each other, direct exchange of information is not carried out.

When the base station C(2, 0) obtains the information regarding the fact that A(2, 1) cannot use the channel a, the use of the channel a is determined, since the priority on the channel a is 2 (next highest priority of the base station A). The base station B(3, 0) learns that C(2, 0), which is the second base station from the base station A to take the channel a as a high priority, wishes to obtain the channel a, and abandons the use of the channel a at the base station B, whereby the unavailability is determined. On the other hand, since the request for the channel by the base station B(3, 0) taking the channel a as a high priority is undetermined, the base station G(3, 1) waits for the request to be determined. Since the statuses of the base station B(3, 0) and the base station C(2, 0) against the channel a have been changed, these base stations inform new request channel information to the adjacent base stations.

After receiving the information regarding that the B(3, 0) does not use the channel a, the base station G(3, 1) determines the user of the channel a, since the other adjacent base stations do not use the channel a, and informs the determination to the adjacent base stations.

In this example, in addition to the request channel information informed by a base station in synchronization with the other base stations, when the request status of the channel is changed, the updated request channel information is transmitted, whereby two of the base stations C(2, 0) and G(3, 1) can use the channel a.

### Third Embodiment

### Time Information

In the above first and second embodiments, availability/unavailability of channels is judged on the basis of the publication time in which the base stations synchronize. Therefore, if transmission of a traffic is completed by the next publication time, new channel allocation is not performed, thus channels cannot be used effectively. Moreover, in the second embodiment, even when the request channel information, which indicates that the channel is determined to be unavailable, is informed to the adjacent base stations after the channel is used, when another base station starts using the channel the request channel information needs to be exchanged again with the adjacent base stations.

In the third embodiment, therefore, time information such as a channel starting time and time in which the channel is used is contained in the request channel information, and the request channel information is informed to the adjacent base stations.

FIG. 16 is a figure showing the request channel information having time information. As shown in FIG. 16, a request of a channel, status of the channel, starting time, and time in which the channel is used are contained.

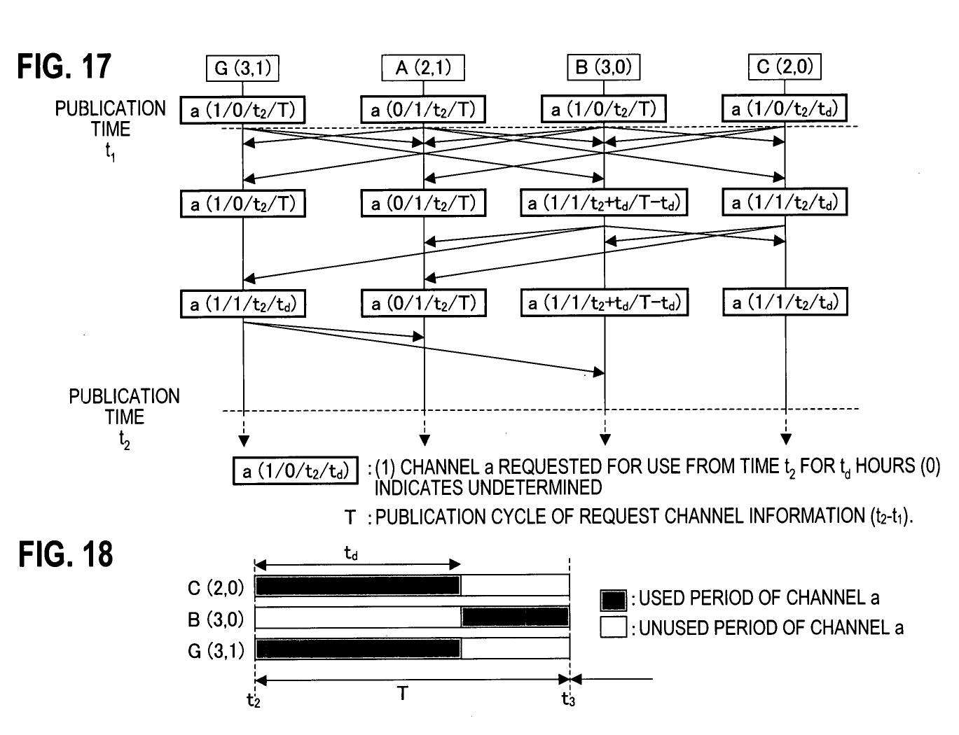

FIG. 17 is a figure showing an example of transmitting the request channel information having the time information and of determining a channel to be used. The example shown in FIG. 17 assumes that the hour in which the base station C(2, 0) requests for the channel a is t_{d}, which is less than a publication time interval T. According to the request channel information informed at the time t₁, C(2, 0) determines the use of the channel a at the time t₂ for t_{d} hours. At the same time, the base station B(3, 0) determines that it can use the channel a after C(2, 0) has used the channel a. At this time, G(3, 1) has not yet determined whether to use the channel a. The base stations B(3, 0) and C(2, 0) inform the updated request channel information. On the basis of the updated request channel information, the base station G(3, 1) determines that it can use the channel a from the time t₂ for t_{d} hours.

FIG. 18 is a figure showing a result of allocation of the channel a. As shown in FIG. 18, the base stations C(2, 0) and G(3, 1) use the channel from the time t₂ after a lapse of t_{d} hours, which is before the cycle T ends, and, after the lapse of t_{d} hours during the cycle of T, the base station B(3, 0) uses the channel.

### Fourth Embodiment

### Pattern of Informing the Information of Second Adjacent Base Station

In FIG. 12, considered is a case in which the longest updating process is required until the base station G(3, 1) determines that it can use the channel a.

According to FIG. 2, since the priority of the base station G is 7, first of all it is necessary to determine that the base station D(3, 2), whose priority is 6, does not use the channel a. When the base station D(3, 2) request for the use of the channel a, the base station E (3, 3), whose priority is higher than that of the base station D by 1, determines the use of the channel a, whereby the base station D(3, 2) abandons the use of the channel a. Similarly, a base station B(2, 3), whose priority is higher by 1, needs to abandon the use of the channel a so that the base station E(3, 3) can use the channel a. In order to carry out this process, it is considered that the base station F(2, 2), whose priority is higher than that of the base station B by 1, uses the channel a. However, since F(2, 2) is placed adjacent to the base station G(3, 1), if F(2, 2) uses the channel a the base station G(3, 1) cannot use the channel a, thus it is assumed that the base station F(2, 2) does not request for the channel a. Consequently, it is supposed that a base station C(1, 3) or base station A(1, 4) uses the channel a in order for the base station B(2, 3) to abandon the use of the channel a.

To summarize the above explanations, the procedure of exchanging the request channel information becomes as follows:

(1) C(1, 3) or A(1, 4) uses the channel a.

(2) B(2, 3) cannot use the channel a.

(3) E(3, 3) uses the channel a. (E(3, 3) is not placed adjacent to C(1, 3) and A(1, 4), and thus can use the channel a without interference with C(1, 3) and A(1, 4). At this moment, it is supposed that A(4, 2), whose priority on the channel a is higher than that of E(3, 3), does not use the channel a.)

(4) D(3, 2) cannot use the channel a.

Therefore, without going through this longest procedures containing four steps, it is impossible to determine whether the base station G(3, 1) can use the channel a. At this moment, if the base station F(2, 2) requests for the channel a, the base station G(3, 1) cannot use the channel a. Therefore, it is supposed that the base station F(2, 2) does not request for the channel a.

On the other hand, the topological distance from the base station related to the above description to the base station G(3, 1) is as follows. Even to the furthest base station A(1, 4), the distance is 3.

D(3, 2): Distance 1

E(3, 3): Distance 2

B(2, 3): Distance 2

C(1, 3): Distance 2

A(1, 4): Distance 3

Since the availability of the channel is judge based on the priorities of the base stations, the four steps as described above are required.

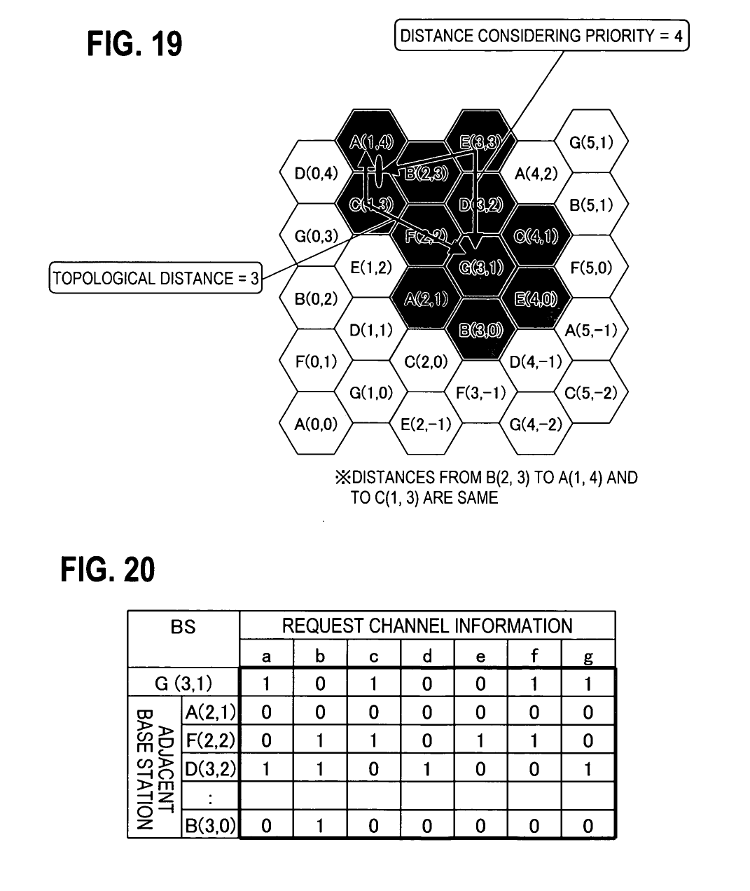

FIG. 19 is a figure showing the distance between base stations viewed from the topological perspective and the perspective of the priorities. In the number of steps corresponding to the distance viewed from the topological perspective, in addition to the request channel information of a base station, the request channel information of adjacent base stations can be contained in the request channel information informed by each base station so that the availability of the channel can be judged.

FIG. 20 is a figure showing the request channel information having information of adjacent base stations. FIG. 20 shows the request channel information of the base station G(3, 1). FIG. 20 is merely a simple example in which a request status of a channel is not included. The request channel information may contain information such as a channel status and time information.

As shown in FIG. 20, by containing the information of the adjacent base stations in the request channel information, the above-described steps can be reduced as follows:

(1) Base station B(2, 3) learns that C(1, 3) or A(1, 4) uses the channel a.

(2) Base station F(2, 2) learns a result of (1) from C(1, 3) or B(2, 3). Moreover, D(3, 2) and E(3, 3) learns the result of (1) from B(2, 3). Furthermore, D(3, 2) learns the request status of an adjacent base station E(3, 3) from E(3, 3), thereby judging whether D(3, 2) can use the channel a.

(3) Base station D(3, 2) notifies the base station G(3, 1) of the availability of the channel a to D(3, 2), as judged in the previous step.

In this manner, the availability of the channel can be judged by going through the number of steps (three steps in the above example) which is same as the topological distance (Distance 3 in the above example).

What is claimed is:

1. A dynamic channel allocation method for dynamically allocating a plurality of channels of a wireless communication network having a plurality of base station groups comprising base stations which do not mutually interfere with one another, wherein the dynamic channel allocation method comprises in each of the base stations:
an informing step of informing channel information requesting for the use of a channel to adjacent base stations which mutually interfere with one another; and
a determination step of determining a channel to be used, in accordance with the priority of each base station group for the use of a channel, the priority being defined for each channel on the basis of the channel information of a base station and the channel information of the adjacent base stations.

2. The dynamic channel allocation method according to claim 1, further comprising a channel information creation step in which each base station creates the channel information on the basis of the traffic amount of the base station.

3. The dynamic channel allocation method according to claim 2, wherein the channel information creation step comprises a step of taking the number of channels, which is sufficient for transmitting a traffic of the base station within a period until the next channel information is informed, as the minimum number of channels requested.

4. The dynamic channel allocation method according to claim 2, wherein the channel information creation step comprises a step of determining the number of required channels in proportion to time for transmitting the traffic.

5. The dynamic channel allocation method according to claim 2, wherein the channel information creation step comprises a step of determining the number of channels on the basis of the traffic amount of each service class and the weight of the each service class.

6. The dynamic channel allocation method according to claim 2, wherein the channel information creation step comprises a step of selecting a channel requested for use, from the high-priority channels in a base station group to which the base station belongs.

7. The dynamic channel allocation method according to claim 2, wherein the channel information creation step comprises a step of selecting a channel having a relatively good characteristic in the base station.

8. The dynamic channel allocation method according to claim 2, wherein the channel information creation step comprises a step of selecting a channel other than a channel which interferes with an adjacent base stations of the base station.

9. The dynamic channel allocation method according to claim 1, wherein the channel information comprises status information about whether a channel requested for use can be used or not.

10. The dynamic channel allocation method according to claim 1, wherein the channel information comprises starting time when the channel requested for use is used.

11. The dynamic channel allocation method according to claim 1, wherein the channel information comprises time in which the channel requested for use is used.

12. The dynamic channel allocation method according to claim 1, wherein the channel information is either an uplink or down link channel information, or both uplink and downlink channel information.

13. The dynamic channel allocation method according to claim 1, wherein, regarding the informing step, each base station informs the channel information, in synchronization with other base station.

14. The dynamic channel allocation method according to claim 9, wherein, regarding the informing step, each base station updates the status information and informs the channel information when a change occurs in the status information.

15. The dynamic channel allocation method according to claim 1, wherein the channel information comprises the channel information of the adjacent base station, in addition to the channel information of the base station.

16. The dynamic channel allocation method according to claim 1, wherein the priority is a value which is different in each base station group for each channel.

17. The dynamic channel allocation method according to claim 1, wherein the difference between the priorities in each channel between any two of the base station groups is minimum.

18. The dynamic channel allocation method according to claim 1, further comprising a channel information creation step of creating the channel information on the basis of the traffic amount of the base station and an immediately preceding channel allocation performance.

19. A dynamic channel allocation apparatus for dynamically allocating a plurality of channels of a wireless communication network having a plurality of base station groups comprising base stations which do not mutually interfere with one another, the dynamic channel allocation apparatus comprising:
an informing portion which informs channel information requesting for use of a channel to adjacent base stations which interfere with one another;
a storage portion which stores a priority table defining the priority of each base station group for each channel; and
a use channel determination portion which determines a channel to be used in accordance with the priority table on the basis of the request channel information of the base station and of the adjacent base stations.
